(19) United States
(12) Patent Application Publication
(10) Pub. No.: US 2011/0094154 A1
(43) Pub. Date: Apr. 28, 2011

(54) MODULAR TUBULAR-SOCK GARDEN GROWING SYSTEM

(76) Inventor: Alan JOAQUIN, Honolulu, HI (US)

(21) Appl. No.: 12/604,132

(22) Filed: Oct. 22, 2009

(51) Int. Cl. A01G 9/02

(52) U.S. Cl. 47/65.8

(57) ABSTRACT

A self-contained garden growing system employs a plurality of modular growing sections, each having a pre-determined length of porous tubular sock material filled with growing medium for plants therein, and having a modular length of irrigation tube installed lengthwise through the growing sock. The opposite ends of the tube have male and female coupling fittings so that a plurality of sections can be coupled together in series, with each growing sock locked in position by the shoulders of the coupling fittings at its opposite ends. The modular sections are of a plurality of types for accommodating different types of plants, volumes of growing medium, and/or watering volumes. The different types of sections each can deliver a pre-determined volume of water that is a multiple of a basic watering volume for the sections, thereby facilitating easy computation of the number and types of sections that can be coupled together in a series for a given water source.

### TECHNICAL FIELD

The present invention is directed to a self-contained garden growing system and method using a porous tubular sock for containment of plant growing medium.

### BACKGROUND OF INVENTION

Self-contained garden growing systems have used a porous tubular sock filled with growing medium for convenient installation and retention of the growing medium at a garden site. In one prior art method, a long section of tubular sock made of mesh or other porous fabric is filled with growing medium such as compost, soil mix, chipped bark, and/or shredded plant material using a bark blower, auger machine, high-speed conveyor machine, or manual means. A drip-irrigation tape may be combined to run along the length inside of the sock to drip water from a water source such as a hose into the growing medium for watering seeds and plants growing therein. Another method has used short sections (called “chubs”) of growing sock pre-filled with growing medium (typically between 2 feet and 4 feet in length) so that they can be mass produced and stacked on pallets to make them easy to distribute, transport and store. Once the chubs are placed in situ at a garden site, a drip-irrigation tape can be installed on or inside the chubs by the installer cutting holes in the upper portion of the sock and feeding the tape through the holes of each chub. The installer may use one continuous length of tape to irrigate several chubs in series, or may use coupling fittings to connect two or more pieces of drip-irrigation tape.

However, the prior art method using one long continuous sock has disadvantages in that the long sock must be filled on site with specialized filling equipment and is heavy and unwieldy for handling. An installer must have the tools, aptitude, and experience required to execute the time consuming and complex installation steps, which precludes doing it oneself. Moreover, water supplied to a long drip-irrigation tape often is not dispensed evenly along the long length of the growing sock. The prior art method using short chub sections is inconvenient in that it requires an installer to cut holes in and run a drip-irrigation tape through the chub sections one after another. It would be desirable to have a self-contained garden growing system using a porous tubular sock for containment of growing medium that is easy to handle, convenient to connect to a water source, and dispenses water evenly along the length of the growing sock.

### SUMMARY OF INVENTION

In accordance with the present invention, a self-contained garden growing system comprises a plurality of modular growing sections, each being comprised of a pre-determined length of porous tubular sock made of a mesh or netting material and pre-filled with growing medium for plants therein, and having a modular length of irrigation tube installed lengthwise through the growing sock with opposite ends thereof projecting through apertures formed in the sock material, wherein a male coupling fitting is attached to one end of the tube and a female coupling fitting to the opposite end, whereby a plurality of modular growing sections can be coupled together in series with each section having its male and female coupling fitting attached to an opposite coupling fitting of an adjoining section.

In a preferred embodiment, the coupling fittings each have a retention ring on a proximal end thereof for receiving a respective end of the section's tube pressed therein and gripping it tightly. The outside surface of the retention ring has a greater diameter than that of the tube and presents an inclined flange or shoulder that abuts the outer surface of the growing sock to prevent it from slipping or sliding longitudinally along the tube. The growing sock becomes locked in position between the shoulders of the retention rings of the male and female coupling fittings at its opposite ends.

As another aspect of the invention, a self-contained garden growing system comprises a plurality of modular sections, each being comprised of a pre-determined length of porous tubular sock made of a mesh or netting material and pre-filled with growing medium for plants therein, and having a modular length of irrigation tube installed lengthwise through the growing sock with opposite ends thereof projecting through apertures formed in the sock material, wherein the modular length of tube has a number of emitter holes distributed over its length which are designed to deliver a pre-determined volume of water by drip irrigation into the growing medium over the length of the growing sock.

In a preferred embodiment, the modular sections are of a standard length and of a plurality of types for accommodating different types of plants, volumes of growing medium, and/or watering volumes from a water source of a given water pressure and delivery volume. The different types of sections each have a respective irrigation tube designed to deliver a pre-determined volume of water that is a multiple of a basic watering volume for the sections, thereby facilitating easy computation of the number and types of sections that can be coupled together in a series for the given water source. The modular sections can be combined in any mixture of types and number within the range of the given water pressure down to a low end water pressure at which water pressure in the tube can be reliably and stably maintained. The sum of water delivery of the modular sections is also kept below the water delivery volume the water source can deliver. The number of modular sections times their standard length equals the total length of the series of modular sections forming the garden growing system.

Other objects, features, and advantages of the present invention will be explained in the following detailed description of the invention having reference to the appended drawings.

### BRIEF DESCRIPTION OF DRAWINGS

FIG. 1 illustrates a self-contained garden growing system in accordance with the present invention employing modular sections having a pre-determined length of tubular sock pre-filled with growing medium for plants and provided with a modular length irrigation tube therein.

FIG. 2 shows a cut-away view of a growing sock filled with growing medium.

FIG. 3 shows a sectional view of the male end of the growing sock.

FIG. 4 shows a sectional view of the female end of the growing sock.

FIG. 5 illustrates a self-contained garden growing method employing a number of modular growing sections coupled by male-to-female coupling of tube ends in a series around a garden site.

### DETAILED DESCRIPTION OF INVENTION

In the following detailed description of the invention, certain preferred embodiments are illustrated providing certain specific details of their implementation. However, it will be recognized by one skilled in the art that many other variations and modifications may be made within the disclosed principles of the invention.

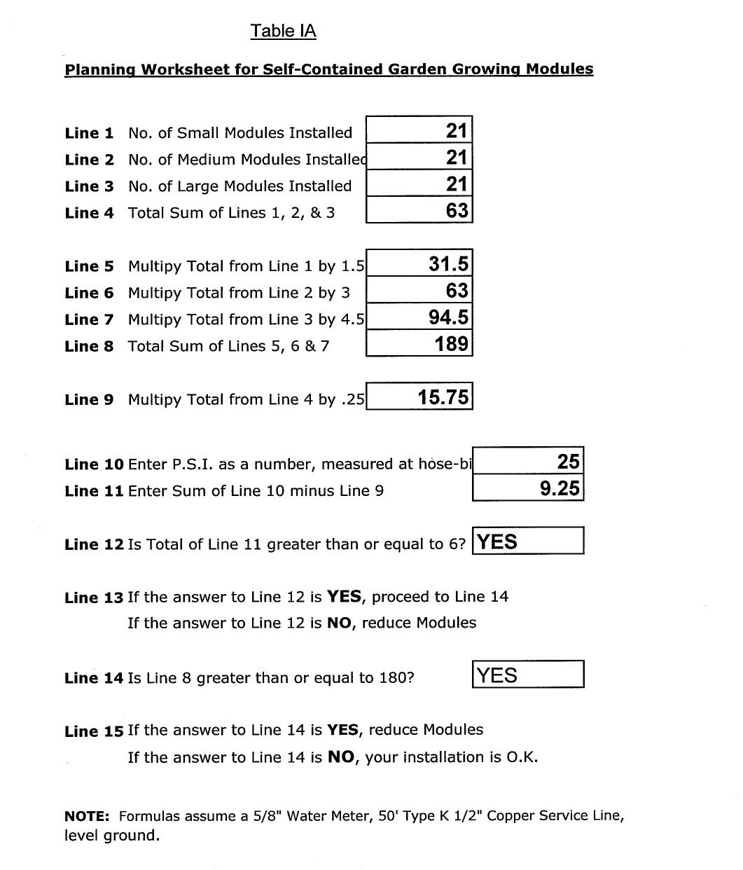

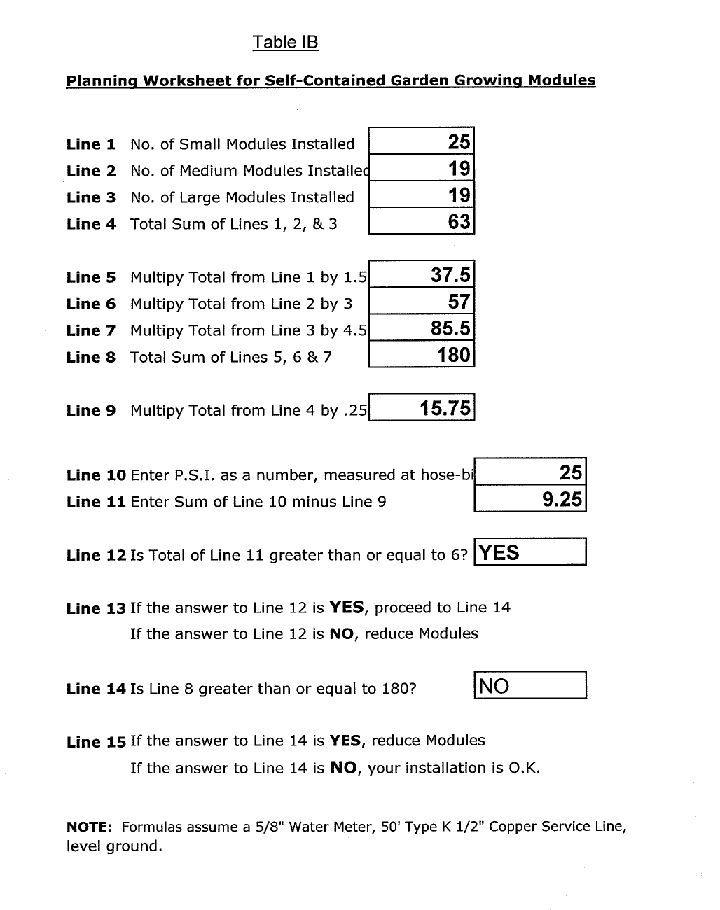

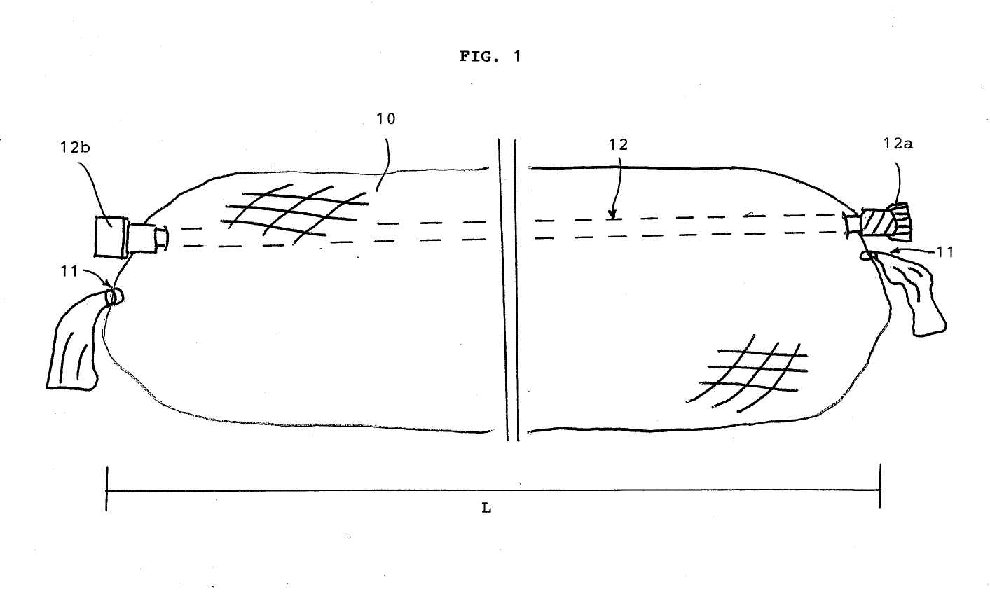

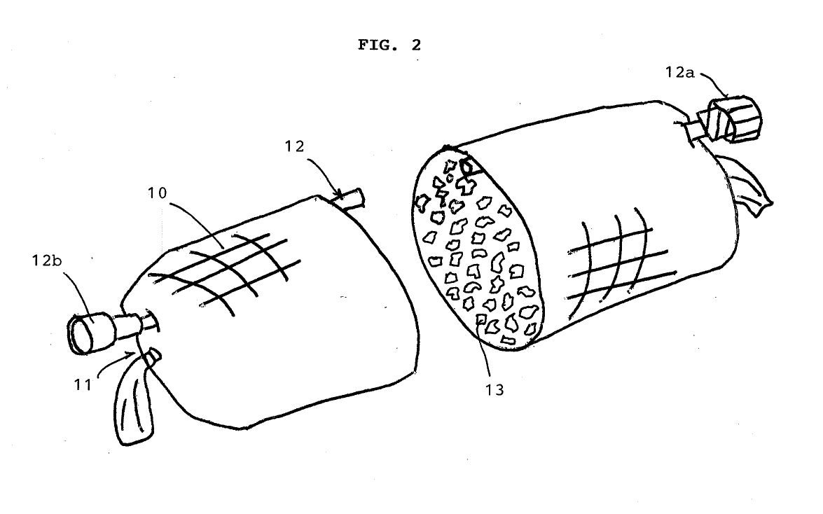

Referring to FIG. 1, a self-contained garden growing system in accordance with the present invention employs modular chub sections 10 each comprised of a pre-determined length L of a porous tubular sock made of a mesh or netting material that is pre-filled with growing medium for plants therein. The length L can be any length convenient for fabrication, filling, distributing, transport, storage, and installation at a garden site. For example, the length L between tied-off ends 11 of the sock can be 3 feet in length, which is convenient for handling and stacking on a pallet, and for computing lengths needed for a garden in feet or yards. The modular sections are filled by the manufacturer using a bark blower, auger machine, high-speed conveyor machine, gravity chute, or manual means. As part of the manufacturing process, a modular length of irrigation tube 12 is installed through the sock having a length matching the length L of the sock between its male end 12a and female end 12b. FIG. 2 shows a cut-away view of a modular growing section filled with growing medium 13.

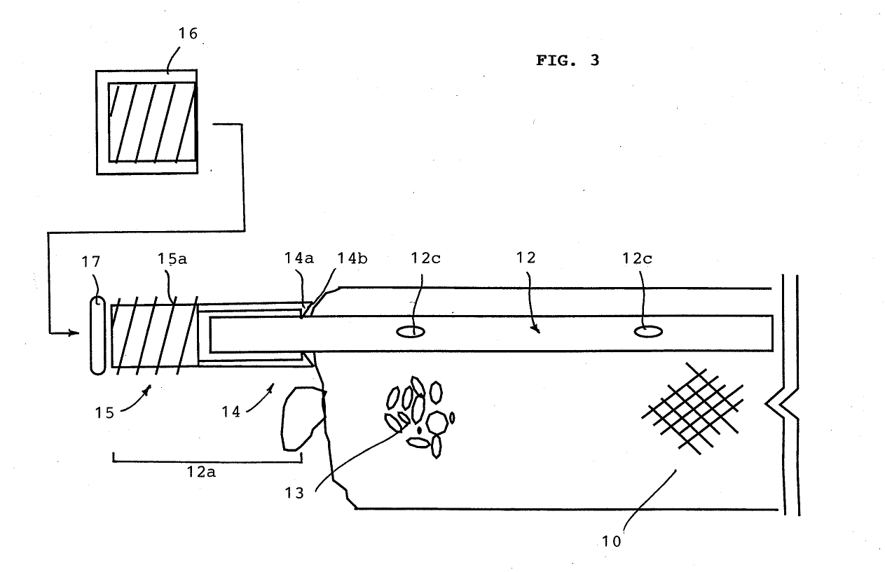

FIG. 3 shows a sectional view of the male end 12a of the growing sock. The end of the irrigation tube 12 is press-fitted into a receiving end 14 of a male coupling fitting 12a and retained tightly therein by a retention ring 14a with a sharp edge that presses into the surface of the tube 12 and grips it tightly. The outside facing surface 14b of the retention ring has a greater diameter than that of the tube 12 and presents an inclined flange or shoulder that abuts the outer surface of the growing sock 10 to prevent it from slipping or sliding longitudinally along the tube 12. The other, connecting end 15 of the male coupling fitting 12a has a threaded outer surface 15a for threading into a female socket of an adjoining modular section, or an end cap 16 as shown in the drawing. An O-ring 17 may be installed on the male threaded end for sealing in the female socket or end cap.

The modular length of tube 12 has a number of emitter holes 12c distributed over its length. The number of emitter holes and their orifice size are designed to deliver a pre-determined volume of water by drip irrigation into the length of the growing sock. As described in detail below, the pre-determined volume of water delivered by each modular section is selected to facilitate easy computation of the number and types of sections that can be coupled together in a series for a water source of given water pressure and water delivery volume. For example, for a tube of 3-foot length the same as the growing sock, there may be 3 emitter orifices spaced from 8″ up to 18″ apart.

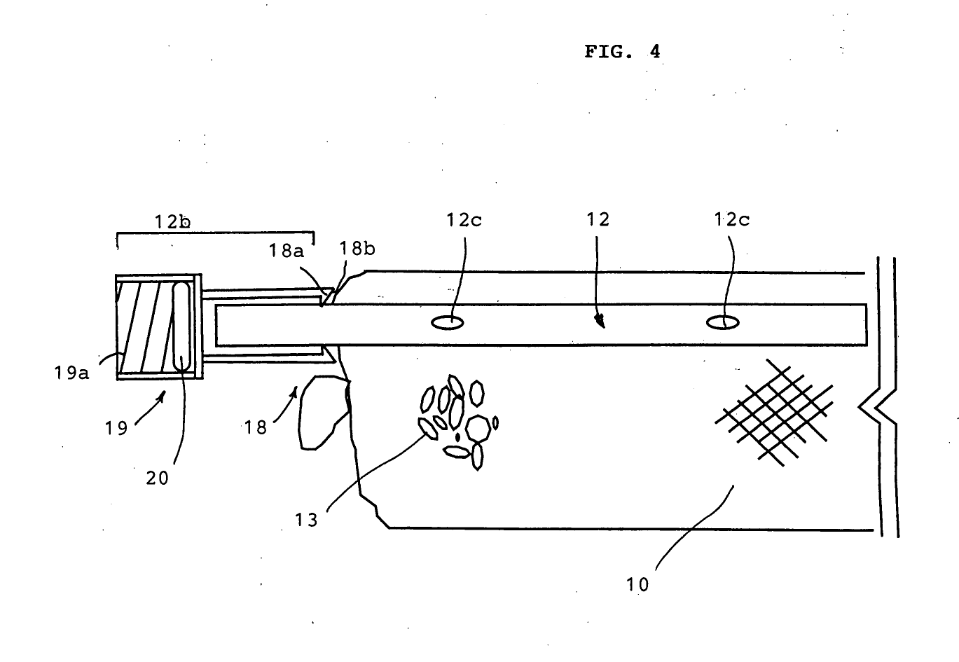

FIG. 4 shows a sectional view of the complementary female end 12b of the growing sock. The end of the irrigation tube 12 is press-fitted into a receiving end 18 of a female coupling fitting 12b and retained tightly therein by a sharp retention ring 18a. The outside facing surface 18b of the retention ring has a greater diameter than that of the tube 12 and presents an inclined flange which, along with the flange 14b of the male coupling fitting 14 on the opposite side of the growing sock 10, locks the growing sock in position to prevent it from slipping or sliding longitudinally along the tube 12. The other, connecting end 19 of the female coupling fitting 12b can be a swivel hose coupling with a threaded inner surface 19a for threading in a male end of an adjoining modular section. An O-ring 20 may be installed in the female threaded end for sealing.

### Modular Assembly of Garden Growing System

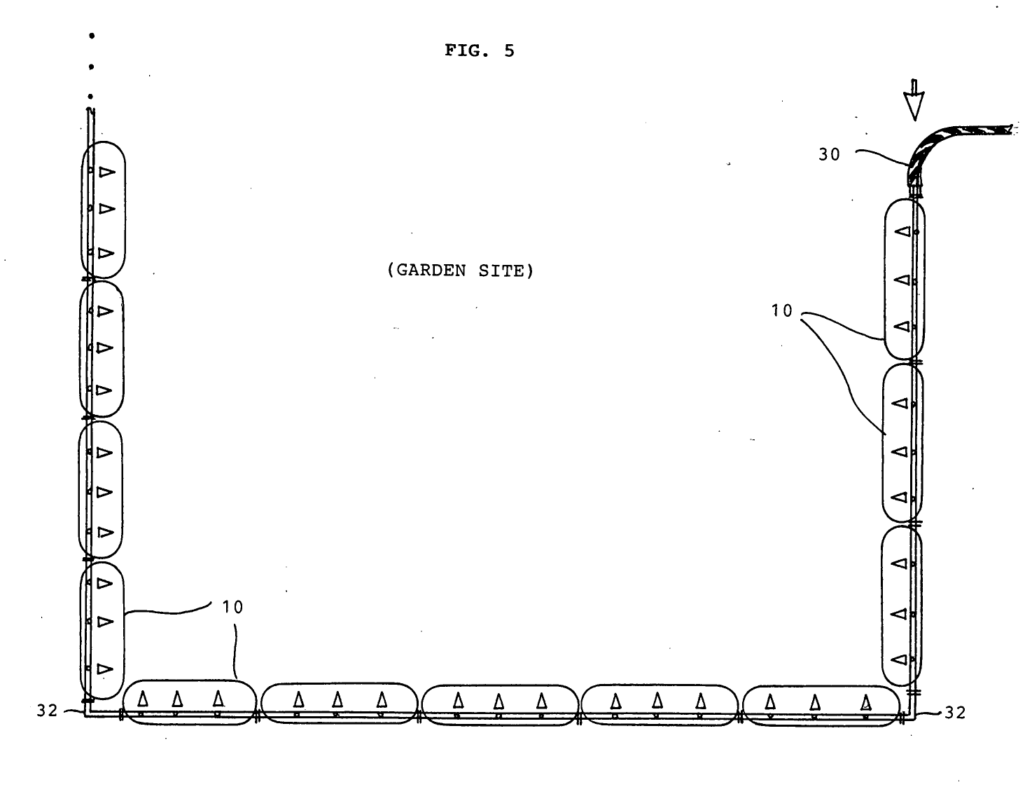

A plurality of the above-described modular sections can be readily combined in an assembly of a garden growing system. In FIG. 5, a self-contained garden growing system is shown having a number of modular sections (12 shown in the drawing) coupled together by male-to-female ends around a garden site. The first one of the modular sections has a female coupling end fitted into the male socket of a water line 30 such as a garden hose. Bend fittings 32 may be used at the corners of the series of modular sections. An ordinary person can easily assemble the modular sections by connecting each male end of a section to the female end of an adjoining section. No special tools, other fittings, or custom or on-site fabricated components would be required, and the task could easily be accomplished.

The modular length L of the modular sections is selected to be a standard length convenient for installation at a garden site, for example, a length L of 3 feet makes it convenient for handling and stacking on a pallet, and for computing lengths needed for the garden site in feet or yards. In the drawing, 12 modular sections of 3-foot length are shown forming a 36-foot perimeter of the garden site. The modular sections may be laid above ground or may be recessed in a trench or buried in the ground. Water from the water line 30 is supplied to the tubes of the modular sections connected in series to drip and permeate into the growing medium contained in each section.

Each modular section is pre-loaded with growing medium such as: compost, compost products, wood shavings, recycled plastics, recycled glass, recycled cellulous, recycled foam, shredded paper, shredded cardboard, plastic beads, Styrofoam, soil mixes, soil amendments, clay, chipped bark, shredded plant material, stolons, rhizomes, sprigs, spores, seeds, peat moss, sphagnum peat moss, hay, coconut fibers, coir fibers, jute fibers, sugar cane fibers, bagasse, cinder, manure, seed hulls, virgin cellulose fiber, hemp fiber, vermiculite, perlite, pumice, polymers, water absorbing agents, absorbents, glues, flocculants, binding agents, gypsum, sand, gravel, pea gravel, lime, worm castings, bat guano, sea kelp, feather meal, bone meal, fish emulsion, hair, flax seed oil, oyster shell, rice hulls, wheat straw, corn fiber, cotton fibers, wool fibers, synthetic fibers, dolomite, organic waste, humate, humic acid, beneficial microorganisms, enzymes, bacteria, fungus, bio-stimulants, microbial inoculants, synthetic fertilizers, organic fertilizers, and nutrient-rich organic plant food. The sections may be pre-seeded with plant seeds, cuttings, or rooted plugs of a desired type or types, or the seeds, cuttings, or rooted plugs may be planted into the sections once installed by puncturing a hole through the mesh material of the growing sock and inserting seeds into the growing medium.

The modular sections can be of standard length in various volume types to accommodate different types of plants, volumes of growing medium, and/or watering volumes. For example, a a-foot long, 9.6-inch diameter section (nominally a “Small” section) can be used for small growing plants requiring water delivery of 1.5 gallons per hour (GPH) of drip irrigation. A 3-foot long, 13.7-inch diameter section (nominally a “Medium” section) can be used for small growing plants with more extensive root systems requiring delivery of 3.0 gallons per hour GPH. A 3-foot long, 16.6-inch diameter section for large growing or thirsty plants (nominally a “Large” section) can be used for water delivery of 4.5 GPH. As a result of the modular configuration, Small sections can be mixed in and installed in-line with Medium and Large Sections, depending on the landscaping plan for the garden site. This is especially useful when a garden row will use plants that have different root zone space requirements. For example, planting lettuce would require a small chub section, and planting carrots would require a large chub section.

The female end of the first section of a series can be hooked directly to the end of a household garden hose and will function as intended assuming the pressure is within normal household ranges, which is typically 50 psi to 10 psi. No special filtration is required assuming the water quality is within normal household ranges. The modular configuration of sections enables easy computation of the total number of sections that may be connected in-line to a garden hose having a given water pressure and water delivery volume. The modular sections can be combined in a number that would take up the hose water pressure down to a low water pressure that can be reliably and stably maintained in the last tube section. The sum of water delivery of the modular sections must also be less than the maximum water volume the hose can deliver. The number of modular sections times their standard length equals the total length of the series. These boundary conditions can be expressed as follows:

PSI Range=WP−minWP

PSI Range≧SUM(sections, modular PSI Drop)

SUM(sections, modular GPH)≦maxWV

#sections×L=Total Series Length

As an example, assume that a typical garden hose has water pressure WP of 25 psi and can deliver a maximum water volume maxWV of 180 gallons per hour, that it can reliably and stably accommodate water demand down to a minimum water pressure minWP of about 6 psi, and that the modular chub sections are manufactured in a modular length L in a standard Small size for water volume of 1.5 GPH, Medium size for 3.0 GPH, and Large size for 4.5 GPH. The expected drop in water pressure for each section can be computed for the given water demand of the different section types. The modular chub sections may be combined in this example in any combination of sizes and number to the boundary conditions of:

PSI Range=19

19≧SUM(sections, modular PSI Drop)

SUM(sections, GPH)≦180 GPH

The following describes an example of a “Planning Worksheet for Self-Contained Garden Growing Modules” that employs the modular assembly method of the present invention. In this example, a 0.25 PSI drop value is assigned to each garden module. The 0.25 PSI drop value is a “Safety Margin” and ensures that a garden site that uses a combination of different size modules (S, M, L) will perform as anticipated under a variety of static and working pressure scenarios. Additionally, a 180 GPH maximum flow rate is used to ensure all water velocities present in the system remain below 7.5 Feet Per Second (FPS), thus preventing water hammer and excessive system pressure loss caused by friction. The 0.25 PSI Value makes an allowance for a wide range of pressure loss values that will result from different modular garden configurations and the associated water velocities which will subsequently occur through; the water source (⅝″ water meter), the service line (50′ Type K 12″ copper tubing), the hose bib, fittings used in the system, and each modular length of irrigation tube (from the female end to the male end). For safety and performance reasons, a ⅝″ water meter was chosen for the computations, as it is typically the smallest water meter used in the building industry and has the highest friction loss values for a given flow rate. For safety and performance reasons, a Type K ½″ copper tubing service line was chosen, as it is typically the smallest service line used in the building industry, and a 50′ run to a hose bib was anticipated, as a 50′ run is typical for most structures. The example worksheet ensures that the system water velocity does not exceed 7.5 FPS, and ensures that a minimum of 6 PSI is maintained at the end of the last modular length of irrigation tube.

Table IA and IB shows an example of 2 different garden site configurations, both of which are serviced by a hose bib that has a static PSI reading of 25, and both of which contain 63 garden modular sections (189′ total series length). The example in Table IA demonstrates relationship between water pressure and water flow. The pressure of a garden installation can be within the minimum PSI tolerance (9.25 PSI is calculated on Line 11) while the water flow velocities can be outside of the 180 GPH threshold. Note a total of 189 GPH is calculated on Line 8. This value is above the 180 GPH threshold, and would result in excessive water flow velocities within the system. Table IA clearly indicates that the garden design is not correct and requires modifications.

Table IB reflects changes made to the original garden design illustrated in Table IA. Note that the static PSI (Line 10) and working PSI (Line 11) are identical to those shown in Table IA, as is the total series length of 189′. Individual garden modular section size, however, was modified from those used in Table IA, specifically; 4 additional smalls were added, 2 mediums were removed, and 2 larges were removed. Table IB shows a total of 180 GPH, as calculated on Line 8, which is acceptable. The garden site planned using Table IB is within PSI and GPH tolerances, therefore the garden modules will function properly.

Table IA and IB demonstrate how a person unskilled in the art can easily design a functioning garden site that uses different sized modules in varying quantities. While site-specific hydraulic calculations are eliminated from the garden site design process, the Modular Tubular-Sock Garden Growing System ensures that a proportioned application rate of water will be delivered to each cubic foot of growing media contained within each of the different sized garden modules throughout the garden site (1 GPH of water per 1 cubic foot of growing medium, plus or minus 3%). The individual garden modules can be arranged in any configuration within the garden site, and can be re-arranged at any time, without jeopardizing overall system performance.

As examples of commercially available components that may be used for the modular garden growing system, the following are noted:

Pressure Compensating Drip Tube: EuroDrip USA, Inc., Madera, Calif. The drip tube is 16 mm, 18 mm, and 20 mm poly tubing which have large turbulent flow path, double filtration inlets, and a pressure compensation range of 6-65 psi, and standard or custom emitter spacing from 8 to 60 inches. Dual self-flushing mechanism flushes at every start-up ensuring reliable operation and less maintenance.

Compression Fittings: DIG Corporation, Vista, Calif. The compression fittings are made of high impact plastic that is UV-resistant and has compression rings for retention that allow secure and easy installation without glues or clamps. It fits all DIG 16 and 17 mm dripline and ½″ polyethylene tubing (0.450, 0.620, 0.700 and 0.710 OD), for operating pressure up to 60 PSI. The body is made of ABS plastic, and the inserts of polycarbonate plastic.

Mesh Sock: MasterNet Ltd., Mississauga, Ontario. The mesh sock netting model 8 DB FS is made of polyester fiber mesh with a filament count of 32-66, with static puncture for 50 ASTM D6241 tested at 1309 N.

The modular configuration of the garden growing system also enables unhealthy plants to be readily replaced in sections. If certain sections were infested with bugs, infected with disease, or were affected by other growth inhibiting conditions, the modules could easily be removed, treated appropriately, and then returned to service, requiring no tools, fittings, repairs, or special skills.

The dripper tube used for the garden growing system is not orientation dependent, and performance is predictable, therefore migration of the tube's orientation is not of concern. As a result, installation of the garden growing system is much easier and does not require special attention to be placed on the internal irrigation system. The tube of each modular section is “locked” into place by the retention ring flanges of the coupling fittings that are attached to the ends of the tube preventing migration. While the tube is smooth, the fittings installed at each end have a larger outside diameter than the tube itself, and do not allow the tube to migrate forward or backward, thus ensuring the drip emitter locations remain constant and perform as designed.

Because the modular garden growing system can be connected directly to the end of a household garden hose, hose thread (HT) fittings are preferred for use on consumer-oriented garden growing systems. The use of HT fittings allows for a garden hose to be connected to the garden growing system without using any special tools, fittings, or adapters. Additionally, the end cap at the end of the last section can be removed and a household garden hose could be connected, thus allowing the user to utilize the water being provided downstream of the garden growing system to also operate a garden hose. This would be especially useful when supplemental watering is required to be made using a mist from a garden hose, but where no extra hose bib connection is available near the garden. Use of HT fittings also makes use of the garden growing system standardized and easy to use for an ordinary person.

The garden growing system can be ordered with the desired sections fully loaded with growing medium and ready to use. No special tools, fittings, or aptitude is required to install a functioning garden. As the growing medium in the sections is self-contained and optimized for growing the intended plants, no fertilizing, roto-tilling, raking, or weeding is necessary. Furthermore, the user can remove, replace, rearrange or relocate certain modules if the need arises, while not compromising the integrity or functionality of the remaining modules. The modular garden growing system is designed to compensate for different water pressure levels and growing sock diameters. Therefore, ordinary persons can quickly and reliably assemble and install the garden growing system.

The garden growing system can be used to form planted borders for controlling erosion, retaining sediment, protecting other plants, and bordering landscaped areas. The modular sections may be filled with different types of growing media, including compost, composted products, mulch, sawdust, soil, gravel, and/or various other organic and/or inorganic substances, and pre-planted with different types of plant seeds, sprigs, stolons, rooted cuttings, rhizomes or plugs.

It is understood that many modifications and variations may be devised given the above description of the principles of the invention. It is intended that all such modifications and variations be considered as within the spirit and scope of this invention, as defined in the following claims.

1. A self-contained garden growing system comprising a plurality of modular growing sections, each being comprised of a pre-determined length of porous tubular sock made of a mesh or netting material and pre-filled with growing medium for plants therein, and having a modular length of irrigation tube installed lengthwise through the growing sock with opposite ends thereof projecting through apertures formed in the sock material, wherein a male coupling fitting is attached to one end of the tube and a female coupling fitting to the opposite end, whereby a plurality of modular growing sections can be coupled together in series with each section having its male and female coupling fitting attached to an opposite coupling fitting of an adjoining section.

2. A self-contained garden growing system according to claim 1, wherein the male and female coupling fittings each have a retention ring with a sharp retention edge on a proximal end thereof for receiving a respective end of the section's tube pressed therein and gripping it tightly.

3. A self-contained garden growing system according to claim 2, wherein each retention ring of the male and female coupling fittings has an outside facing surface with a greater diameter than that of the tube and presents an inclined flange or shoulder that abuts the outer surface of the growing sock to prevent it from slipping or sliding longitudinally along the tube.

4. A self-contained garden growing system according to claim 3, wherein the growing sock of each modular section becomes locked in position between the shoulders of the retention rings of the male and female coupling fittings at its opposite ends.

5. A self-contained garden growing system according to claim 1, wherein a first modular growing section of the plurality of sections coupled together in a series is coupled to a water source.

6. A self-contained garden growing system according to claim 5, wherein the first modular growing section has a female coupling fitting end coupled to a male receptacle of a garden hose as a water source.

7. A self-contained garden growing system according to claim 6, wherein a last modular growing section of the plurality of sections has a female end cap attached to its last male coupling fitting end.

8. A self-contained garden growing system according to claim 6, wherein a last modular growing section of the plurality of sections has its last male coupling fitting end attached to an ancillary garden hose for remote watering.

9. A self-contained garden growing system according to claim 1, wherein each modular growing section is pre-loaded with growing medium of one or more of: compost, compost products, wood shavings, recycled plastics, recycled glass, recycled cellulous, recycled foam, shredded paper, shredded cardboard, plastic beads, Styrofoam, soil mixes, soil amendments, clay, chipped bark, shredded plant material, stolons, rhizomes, sprigs, spores, seeds, peat moss, sphagnum peat moss, hay, coconut fibers, coir fibers, jute fibers, sugar cane fibers, bagasse, cinder, manure, seed hulls, virgin cellulose fiber, hemp fiber, vermiculite, perlite, pumice, polymers, water absorbing agents, absorbents, glues, flocculants, binding agents, gypsum, sand, gravel, pea gravel, lime, worm castings, bat guano, sea kelp, feather meal, bone meal, fish emulsion, hair, flax seed oil, oyster shell, rice hulls, wheat straw, corn fiber, cotton fibers, wool fibers, synthetic fibers, dolomite, organic waste, humate, humic acid, beneficial microorganisms, enzymes, bacteria, fungus, bio-stimulants, microbial inoculants, synthetic fertilizers, organic fertilizers, and nutrient-rich organic plant food.

10. A self-contained garden growing system according to claim 1, wherein the plurality of modular growing sections are of one or more different types of: growing medium, section volume, and tube watering delivery.

11. A self-contained garden growing system comprising a plurality of modular growing sections, each being comprised of a pre-determined length of porous tubular sock made of a mesh or netting material and pre-filled with growing medium for plants therein, and having a modular length of irrigation tube installed lengthwise through the growing sock with opposite ends thereof projecting through apertures formed in the sock material, wherein the modular length tube has a number of emitter holes distributed over its length which are designed to deliver a pre-determined volume of water by drip irrigation into the growing medium over the length of the growing sock.

12. A self-contained garden growing system according to claim 11, wherein the plurality of modular growing sections are of a plurality of types having respective irrigation tubes designed to deliver a respective pre-determined volume of water that is a multiple of a basic watering volume for the sections, thereby facilitating easy computation of the number and types of sections that can be coupled together in a series for a given water pressure and delivery volume of a water source.

13. A self-contained garden growing system according to claim 12, wherein the modular growing sections can be combined up to a maximum number of sections that would take up the given water pressure down to a low water pressure that can be reliably and stably maintained in a tube section.

14. A self-contained garden growing system according to claim 12, wherein the modular growing sections can be combined up to a maximum number of sections that would take up the given water delivery volume down to a low water delivery volume that can be reliably and stably maintained in a tube section.

15. A self-contained garden growing system according to claim 12, wherein the modular growing sections are of small, medium and large types, with the small type capable of delivering the basic watering volume, the medium type capable of delivering twice the basic watering volume, and the large type capable of delivering three times the basic watering volume.

16. A method for self-contained garden growing comprising:
providing a plurality of modular growing sections, each being comprised of a pre-determined length of porous tubular sock made of a mesh or netting material and pre-filled with growing medium for plants therein, and having a modular length of irrigation tube installed lengthwise through the growing sock with opposite ends thereof projecting through apertures formed in the sock material, and
enabling the delivery through the irrigation tube for each modular growing section a pre-determined volume of water by drip irrigation into the growing medium over the length of the growing sock.

17. A method for self-contained garden growing according to claim 16, wherein the plurality of modular growing sections are of a plurality of types having respective irrigation tubes designed to deliver a respective pre-determined volume of water that is a multiple of a basic watering volume for the sections.

18. A method for self-contained garden growing according to claim 17, combining modular growing sections up to a maximum number that would take up a given water pressure down to a low water pressure that can be reliably and stably maintained in a tube section.

19. A method for self-contained garden growing according to claim 17, wherein the growing modular sections can be combined up to a maximum number that would take up a given water delivery volume down to a low water delivery volume that can be reliably and stably maintained in a tube section.

20. A method for self-contained garden growing according to claim 17, wherein the modular growing sections are of small, medium and large types, with the small type capable of delivering the basic watering volume, the medium type capable of delivering twice the basic watering volume, and the large type capable of delivering three times the basic watering volume.
